(19) United States
(12) Patent Application Publication
(10) Pub. No.: US 2006/0037021 A1
(43) Pub. Date: Feb. 16, 2006

(54) System, apparatus and method of adaptively queueing processes for execution scheduling

(75) Inventors: Vaijayanthimala K. Anand, Austin, TX (US); Sandra K. Johnson, Austin, TX (US)

Correspondence Address: IBM CORPORATION (VE);C/O VOLEL EMILE, P. O. BOX 202170, AUSTIN, TX, 78720-2170, US

(73) Assignee: International Business Machines Corporation, Armonk, NY (US)

(21) Appl. No.: 10/916,982

(22) Filed: Aug. 12, 2004

(51) Int. Cl. G06F 9/46

(52) U.S. Cl. 718/102

(57) ABSTRACT

A system, apparatus and method of adaptively queueing processes for execution scheduling are provided. When a process yields its processor to another process, it is generally placed in a queue before it is re-scheduled for execution. If it is re-scheduled for execution within a longer period of time than needed, the next time it has to be placed in a queue, it will be placed in a queue or at a location in a queue where it will be scheduled for execution in a shorter amount of time. If it is re-scheduled for execution within a period of time that is shorter than needed, the next time it has to be placed in a queue, it will be placed in a queue or at a location in a queue where it will be scheduled for execution within a longer period of time.

### BACKGROUND OF THE INVENTION

1. Technical Field

The present invention is directed to process scheduling. More specifically, the present invention is directed to a system, apparatus and method of adaptively queueing processes for execution scheduling.

2. Description of Related Art

At any given processing time, there may be a multiplicity of processes or threads waiting to be executed on a processor or CPU of a computing system. To best utilize the CPU of the system then, it is necessary that an efficient mechanism that properly queues the processes or threads for execution be used. The mechanism used by most computer systems to accomplish this task is a scheduler.

Note that a process is a program. When a program is executing, it is loosely referred to as a task. In most operating systems, there is a one-to-one relationship between a task and a program. However, some operating systems allow a program to be divided into multiple tasks or threads. Such systems are called multithreaded operating systems. For the purpose of simplicity, threads, processes and tasks will henceforth be used interchangeably.

A scheduler is a software program that coordinates the use of a computer system's shared resources (e.g., a CPU). The scheduler usually uses an algorithm such as a first-in, first-out (i.e., FIFO), round robin or last-in, first-out (LIFO), a priority queue, a tree etc. algorithm or a combination thereof in doing so. Basically, if a computer system has three CPUs (CPU₁, CPU₂ and CPU₃), each CPU will accordingly have a ready-to-be-processed queue or run queue. If the algorithm in use to assign processes to the run queue is the round robin algorithm and if the last process created was assigned to the run queue associated with CPU₂, then the next process created will be assigned to the run queue of CPU₃. The next created process will then be assigned to the run queue associated with CPU₁ and so on. Alternatively, each CPU may have its own scheduler. In this case, the scheduler will only schedule processes to run on the CPU with which it is associated. In any case, schedulers are designed to give each process a fair share of a computer system's resources.

In order to inhibit one process from preventing other processes from running on an assigned CPU, each process has to take turns running on the assigned CPU. Thus, another duty of the scheduler is to assign units of CPU time (e.g., quanta or time slices) to processes. A quantum is typically very short in duration, but processes receive quanta so frequently that the system appears to run smoothly, even when many processes are performing work.

Sometimes a system administrator may want different processes to receive a different share of the CPU time, for example. In that case, a workload manager (WLM) is used in conjunction with the scheduler. The WLM assigns a priority to each process. Each time a process consumes some CPU time, its priority is reduced. This scheme allows processes that have a low priority to nonetheless receive some CPU time.

In certain implementations, when a process becomes ready to execute, it is sorted into position, according to its priority, on a queue called the current queue. The scheduler then only has to choose the process at the most favorable position on the queue to schedule for execution. Consequently, scheduling is done in a constant amount of time. When a process has exhausted its quantum, it is moved to another queue called the expired queue and sorted, again, according to its priority. Eventually, all of the tasks on the current queue will be executed and moved to the expired queue. When this happens, the queues are switched (i.e., the expired queue becomes the current queue and the empty current queue becomes the expired queue). As the tasks on the new current queue have already been sorted, the scheduler can once again resume its simple algorithm of selecting the task in the most favorable place from the queue.

When a process is being processed by a CPU and for some reason needs to wait for a shared resource before proceeding, for efficiency reasons, the process may yield or cede the rest of its turn at the CPU to another process. If the process has a lock on a shared kernel resource, it may not relinquish the lock before yielding the CPU. For example, when a first process is using a shared kernel resource such as a buffer, it will put a lock on the buffer to prevent all other processes from using the buffer. If the first process was performing some disk input/output (I/O) and needed some data in a register that is being used by a second process (i.e., the second process has a lock on the register), instead of having the CPU stay idle while waiting for the second process to release the lock on the register, the first process may allow a third process to use the CPU.

When a process yields its CPU to another process while waiting for a shared resource to become available, it is generally placed in a wait queue of its priority level. Presently, several options are used when placing a process in a wait queue. One of the options is to place the yielding process, next to the process at the head of the wait queue. Another option is to place the yielding process at the end of the wait queue. Yet, another option is to bypass the wait queue altogether and place the yielding process in the expired queue.

Obviously, when the yielding process is placed next to the process at the head of the wait queue, it will be scheduled for execution after the process at the head of the queue has been scheduled for execution. By contrast, when the yielding process is placed at the end of the wait queue, it will be scheduled for execution after all the processes in the wait queue have been scheduled for execution. However, when the yielding process is placed in the expired queue, it will be scheduled for execution after all processes of all priority levels have been scheduled for execution.

At certain times, one option may enable a computer system to perform much better than another option whereas at other times a different option may do so. Since, computer systems are generally designed with only one of the three options implemented therein, a computer system may, at different times, perform better or poorer than usual.

Thus, what is needed is a system, apparatus and method of adaptively queueing processes for execution scheduling.

### SUMMARY OF THE INVENTION

The present invention provides a system, apparatus and method of adaptively queueing processes for execution scheduling. When a process is executing and it is in need of a shared resource that is being used by another process, for efficiency reasons, it may yield its processor to another process. When it does so, it will be placed in a queue in order to wait for the release of the shared resource. After a certain period of time has elapsed, the process may be scheduled for execution. If the period of time is too long, the process will spend too much time in the queue. If the period of time is instead too short, the process will be scheduled for execution before the shared resource has been released by the other process. Hence, it will be dispatched for execution in vain.

Accordingly, the invention determines whether the period of time is too short or too long. If the period of time is too long, the next time the process has to wait for the shared resource, it will be placed in a queue or at a location in a queue where it will be scheduled for execution in a shorter amount of time. If the period of time is too short, the process may then be placed in a queue or at a location in a queue where it will be scheduled for execution within a longer period of time.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a flowchart of a process that may be used when the policy is based on the number of times a task is placed in a queue.

FIG. 2 is a flowchart of a process that may be used when the policy is based on the amount of time a task spends in a queue before it is scheduled for execution.

FIG. 3 is a flowchart of a process that may be used when the policy is based on the amount of time elapsed between two yielding times.

FIG. 4 is a flowchart that may be used when an application program provides hints in assisting with task scheduling.

FIG. 5 is a block diagram of an exemplary multi-processor system in which the present invention may be implemented.

### DETAILED DESCRIPTION OF THE PREFERRED EMBODIMENT

The invention uses an adaptive policy to place yielding processes in a queue for execution scheduling. Initially, a yielding process may be placed in a queue as per one of the options previously described (i.e., next to the first process in a wait queue, at the end of the wait queue or in an expired queue). Then, the process adapts to the other two options, or variations thereof, based upon some metric (i.e., the number of times the process is associated with a specific option or based upon application program hints or frequency of yields from the same process within a short period of time etc.).

The policy details the rules for determining when to adapt to a different option. Particularly, the policy may be based on the number of times a task is placed in a queue or at a particular location in a queue. Alternatively, the policy may be based on the amount of time a task spends in a queue before being scheduled for execution. Or, the policy may be based on the amount of time that has elapsed between two yielding times (i.e., the delta time between two succeeding times that a task yields its processor).

If the policy is based on the number of times a task is placed in a queue, each time the task is placed in a particular queue (e.g., a wait queue or an expired queue, if in a wait queue then the location where it is placed in the queue), a counter may keep track of how many times the task is placed in the particular queue or the location in the queue. When the number of times the task has been placed in the particular queue or at the particular location in the queue exceeds a threshold (i.e., a max_queue_count), which may either be user-configurable, dynamic or static, a new option may be used. For example, suppose the task is placed next to the first task in the wait queue each time it yields its processor. If the threshold is exceeded, then, this may mean that there was not enough time between executions of the task to allow for the release of the resource for which it waits. The time may then be lengthened by placing the task at the end of the wait queue (i.e., the longer it takes before the task is re-scheduled for execution the longer the time between executions). Likewise, if the threshold is exceeded while the yielding task is being placed at the end of the wait queue, the task may be placed in the expired queue to further lengthen the time between executions.

If the policy is based on the amount of time a task spends in a queue before it is scheduled for execution, then when a task is placed in a queue, a counter may keep track of the time the task actually spends in the queue before it is scheduled for execution. If the task stays in the queue for a time that is equal or greater than a threshold (i.e., a max_queue_time), which may either be user-configurable, dynamic or static, it may mean that the yielding task is spending too much time waiting for the release of the resource. In this case, a different option may be used. Specifically, if the task was placed in the expired queue when the threshold was exceeded, then, it may be placed in the wait queue. Initially, it may be placed at the end of the wait queue. If while being placed there, the threshold is again exceeded, it may then be placed next to the first task in the queue.

If the policy is based on the amount of time that has elapsed between yielding times; again, a counter may be used to keep track of the delta time between any two successive yielding times. If the delta time is less than or equal to a user-configurable, dynamic or static threshold (i.e., an inter_yield_time) while a particular option is being used, it may mean that the time between executions of the task is not long enough. Thus, an option that provides a longer period of time may be used. That is, if the yielding task was placed next to the first task in the wait queue when the threshold is exceeded, it may be placed at the end of the wait queue. If the yielding time continues to exceed the threshold while the task is at the end of the wait queue, then it may be placed in the expired queue.

As mentioned above, when the two thresholds, max_queue_count and inter_yield_time, are exceeded, it means that not enough time has elapsed between executions of a task. By contrast, when the threshold max_queue_time is exceeded it means that too much time has elapsed between executions of a task. Consequently, either the max_queue_count or the inter_yield_time may be used in conjunction with the max_queue_time to ensure that a computer system within which the invention is implemented is performing at its optimum.

Further, unless suggested by an application through hints (explained below), the ideal option to use initially when the policy is based on the number of times a task is placed in a queue is to place the task in the wait queue next to the first task. Then, if the threshold continues to be exceeded it can be placed at the end of the wait queue then into the expired queue in a stepwise fashion. Likewise, the ideal initial option when the policy is based on the amount of time that has elapsed between two yielding times is to place the task in the wait queue next to the first task, then at the end of the wait queue and then into the expired queue as the threshold continues to be exceeded. However, when the policy is based on the amount of time a task spends in a queue before being scheduled for execution, the task may ideally be placed initially in the expired queue, then at the end of the wait queue and then next to the first task in the wait queue as needed. When the policy is based on two simultaneous options (e.g., when max_queue_count and max_queue_time are used in conjunction with each other), a task may initially be placed next to the first option in the wait queue and proceed stepwise to the expired queue as the max_queue_count threshold is being exceeded. However, if at any time the max_queue_time is exceeded, the adjustment may be made in the other direction. Alternatively, a task may initially be placed in the expired queue and as the threshold max_queue_time is being exceeded it may be placed at the end of the wait queue and next to the first task in the wait queue in a stepwise manner. If at any time the max_queue_count is exceeded, the adjustment may be made in the other direction.

Note that in the above description of the invention, a yielding task is placed either next to a first task in a wait queue or at the end of the wait queue. However, the invention is not thus restricted. That is, the yielding task may be placed anywhere within the wait queue other than next to the first task in the wait queue or at the end of the wait queue. In those cases, the yielding task may be placed after X tasks in the wait queue, where X may be a default number, a configuration parameter, a dynamically tunable parameter, an application hint etc.

An application hint may be a suggestion from a running application regarding task scheduling. For example, an application may indicate which tasks should be given a high, medium or low yield priority. Yield priority, in this case, is the amount of time a yielding task should wait before it is queued for execution. A task that has been given a low yield priority may have to wait longer than a task that has been given a high yield priority.

Obviously, an application may not be able to determine with certainty the amount of time a task has to wait before it is to be dispatched for execution since this may depend on many external events over which the application has no control (e.g., the length of time a task may hold the shared resource for which the yielding task is waiting). However, the yield priority, as supplied by the application, may be used as a hint by the scheduler in making queueing decisions. For example, when an application hint is used in conjunction with the thresholds max_queue_count and max_queue_time, a yielding task may be held for longer (if it has been given a low yield priority) or shorter (if it has been given a high yield priority) periods of time relative to yielding tasks that do not have such priorities associated with them. More specifically, if a yielding task is given a high yield priority, it may be queued for execution scheduling after Y max_queue_count or for an amount of time that is equal to Z max_queue_time, where Y and Z may be static, configuration parameters, dynamically tunable parameters or themselves application hints. Note however, if an application knows with certainty how long a task is to wait, it can inform the scheduler of such an absolute requirement.

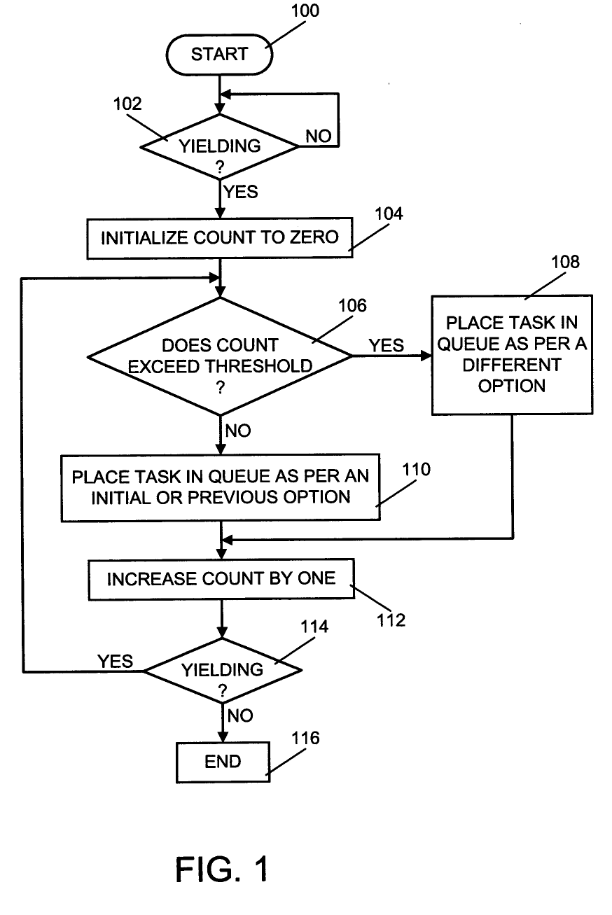

FIG. 1 is a flowchart of a process that may be used when the policy is based on the number of times a task is placed in a queue. The process starts when the task is executing (step 100). Then a check is made to determine whether the task is yielding its processor to another task (step 102). If so, a variable named ‘count’ may be initialized to zero (step 104). After initializing variable count, a check is made to determine whether the value of variable count exceeds threshold max_queue_count (step 106). As mentioned before, threshold max_queue_count may be static or user-configurable. In either case, however, it is set when the computer system on which the invention is implemented is turned on or is reset. Thus, it will have been set before the comparison occurs.

If the value of variable count does not exceed threshold max_queue_count, the yielding task is placed in queue as per an initial or a previous option (step 110). If, on the other hand, the value of count does exceed threshold max_queue_count then the yielding task is put in queue as per a different option (step 108). In either case (i.e., steps 108 and 110), the value of count is increased by one (step 112). If the task yields its processor again, the process will jump back to step 106. Otherwise, the process ends (step 116).

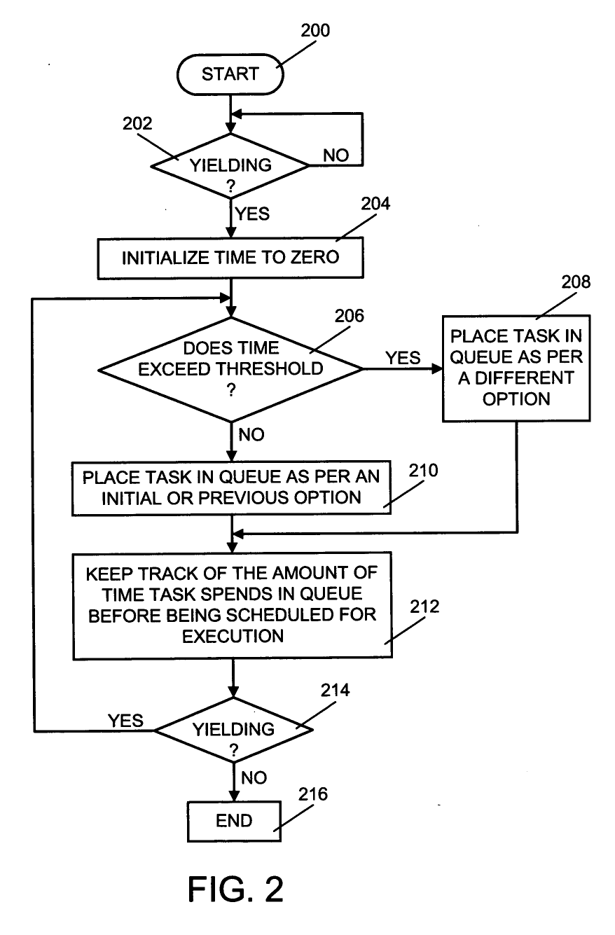

FIG. 2 is a flowchart of a process that may be used when the policy is based on the amount of time a task spends in a queue before it is scheduled for execution. The process starts when the task is executing (step 200). Then a check is made to determine whether the task is yielding its processor to another task (step 202). If so, a variable named ‘time’ may be initialized to zero (step 204). After initializing variable time, a check is made to determine whether the value of the variable exceeds threshold max_queue_time (step 206). As in the case of threshold max_queue_count, max_queue_time may be static or user-configurable and will have been set before the comparison.

If the value of variable time does not exceed threshold max_queue_time, the yielding task is placed in queue as per an initial or a previous option (step 210). If, on the other hand, the value of count does exceed threshold max_queue_time, then the yielding task is put in queue as per a different option (step 208). In either case (i.e., steps 208 and 210), the amount of time that the task spends in the queue is recorded (step 212). If the task yields its processor again, the process will jump back to step 206. Otherwise, the process ends (step 216).

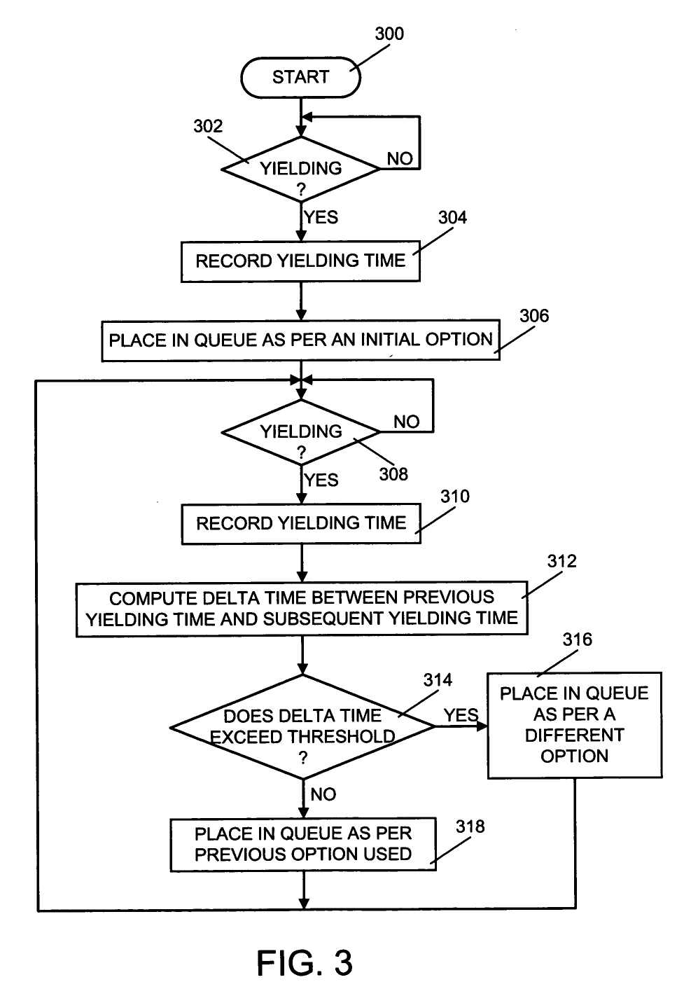

FIG. 3 is a flowchart of a process that may be used when the policy is based on the amount of time elapsed between two yielding times. The process starts when the task is executing (step 300). Then a check is made to determine if the task yields its processor to another task (step 302). If so, the time at which the task yields its processor is recorded (step 304) and the yielding task is placed in a queue as per an initial option (step 306). If the task yields its processor again (step 308), the yielding time is again recorded (step 310) in order to compute the delta time between the previous yield time and the succeeding yield time (step 312). The computed delta time is compared with the inter_yield_time threshold (step 314). As with the other thresholds, the inter_yield_time threshold may be static or user-configurable and will have been set before the comparison. If the computed delta time is greater than the inter_yield_time threshold, the yielding task will be placed in a queue as per a different option (step 316). If, on the other hand, the computed delta time is less than the inter_yield_time threshold, the yielding task will be put in a queue as per the previous option (step 318) and the process will jump back to step 308.

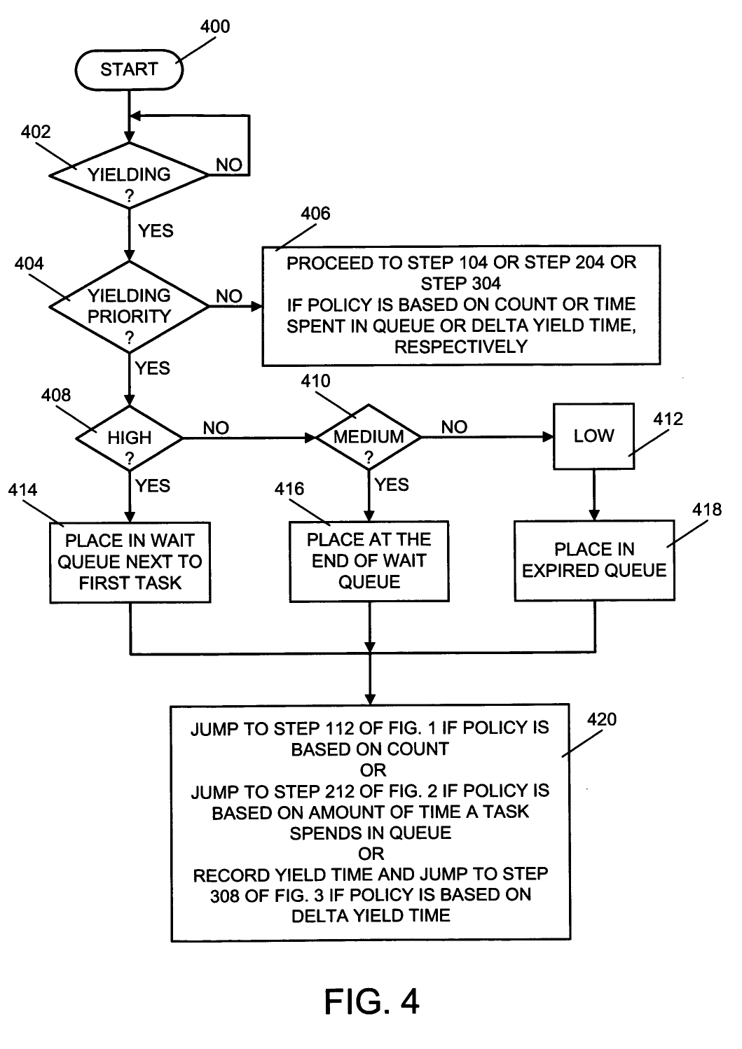

FIG. 4 is a flowchart that may be used when an application program provides hints in assisting with task scheduling. The process starts when a task is executing (step 400). Then a check is made to determine whether the task is yielding its processor to another task (step 402). If so, another check is made to determine whether the application program provides a yield priority (step 404). If the application does not provide a yield priority, then the process jumps to step 104 or step 204 or step 304 of FIG. 1, 2, or 3 if the policy being used is based on count or on time spent in a queue or on delta yield time, respectively (step 406). If, on the other hand, the application program provides a scheduling hint, then a check is made to see whether the hint is a high yield priority (step 408), a medium yield priority (step 410) or a low yield priority (step 412).

If the hint is a high yield priority, the yielding task is placed in the wait queue next to the first task in the queue (step 414). If the hint is a medium yield priority, the yielding task is instead placed at the end of the wait queue (step 416). If, however, the hint is a low yield priority, the yielding task is placed in the expired queue (step 418). After placing the yielding task in a queue, the process may jump back to step 112 of FIG. 1 if the policy in used is based on how many times the task has been placed in a queue, or step 212 of FIG. 2 if the policy is based on time spent in a queue or step 308 of FIG. 3 if the policy is based on delta yield time.

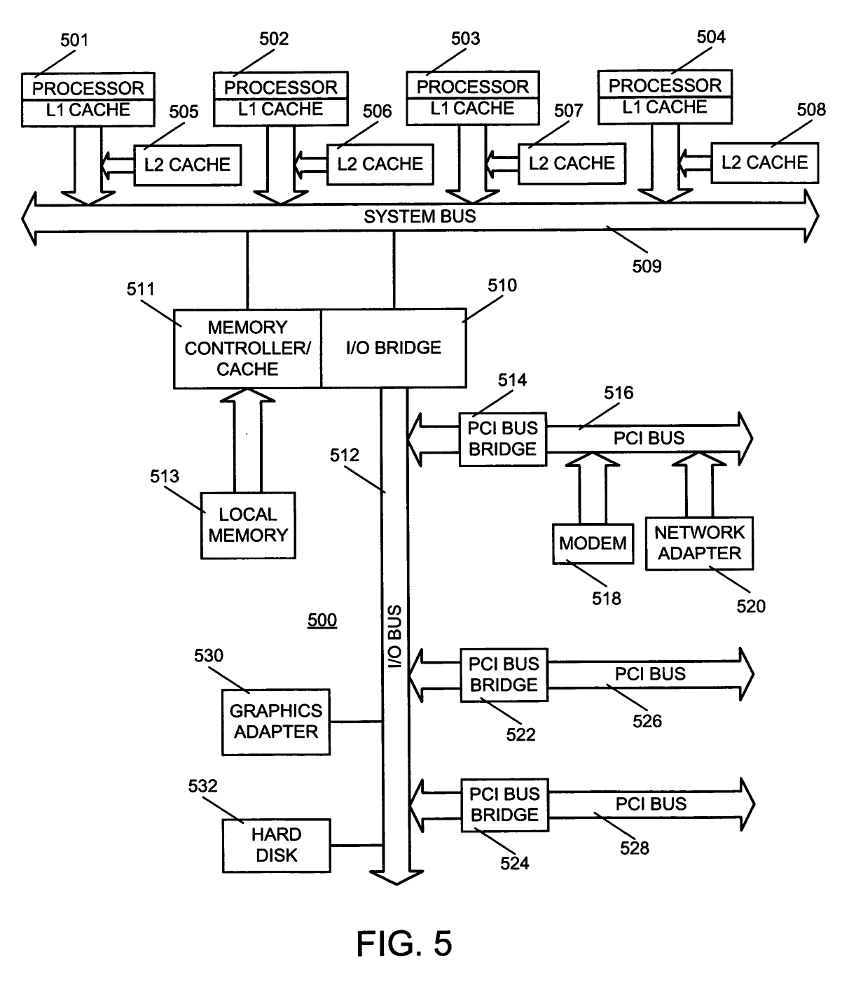

FIG. 5 is a block diagram of an exemplary multi-processor system in which the present invention may be implemented. The exemplary multi-processor system may be a symmetric multi-processor (SMP) architecture and is comprised of a plurality of processors (501, 502, 503 and 504), which are each connected to a system bus 509. Interposed between the processors and the system bus 509 are two respective caches (integrated L1 caches and L2 caches 505, 506, 507 and 508), though many more levels of caches are possible (i.e., L3, L4 etc. caches). The purpose of the caches is to temporarily store frequently accessed data and thus provide a faster communication path to the cached data in order to provide faster memory access.

Connected to system bus 509 is memory controller/cache 511, which provides an interface to shared local memory 509. I/O bus bridge 510 is connected to system bus 509 and provides an interface to I/O bus 512. Memory controller/cache 511 and I/O bus bridge 510 may be integrated as depicted.

Peripheral component interconnect (PCI) bus bridge 514 connected to I/O bus 512 provides an interface to PCI local bus 516. A number of modems may be connected to PCI local bus 516. Typical PCI bus implementations will support four PCI expansion slots or add-in connectors. Communications links to a network may be provided through modem 518 and network adapter 520 connected to PCI local bus 516 through add-in boards.

Additional PCI bus bridges 522 and 524 provide interfaces for additional PCI local buses 526 and 528, from which additional modems or network adapters may be supported. In this manner, data processing system 500 allows connections to multiple network computers. A memory-mapped graphics adapter 530 and hard disk 532 may also be connected to I/O bus 512 as depicted, either directly or indirectly.

Those of ordinary skill in the art will appreciate that the hardware depicted in FIG. 5 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 5 may be, for example, a computer system running the Advanced Interactive Executive (AIX) operating system, a product of International Business Machines Corporation or the Linux operating system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of adaptively queueing processes for execution scheduling comprising the steps of:
initially scheduling a task using one of a plurality of scheduling options based upon at least one of a default parameter and an application hint; and
subsequently scheduling the task to a different one of the plurality of scheduling options based upon a processing metric.

2. The method of claim 1 wherein the metric is based upon at least one of an amount of wait time, a number of times the task was assigned to a given option, application hints, a number of times or amount of time the task is enqueued on a given queue, a number of times or amount of time a task is enqueued at a given location on a given queue, a number of times a yield is called for a given time interval, and a time between yield calls for a specific task.

3. A method of adaptively queueing processes for execution scheduling comprising the steps of:
initially placing a first process in a first queue for execution scheduling, the first process yielding a processor on which it is executing to a second process while awaiting release of a shared resource that is being used by a third process;
determining whether the first process spent more time than needed in the first queue; and
placing the first process in a second queue if it is determined that the first process spent more time than needed in the first queue, the second queue enabling the first process to be scheduled for execution in a shorter time than the first queue.

4. The method of claim 3 wherein it is determined whether the first process spent less time than needed in the first queue rather than more time than needed in the first queue, the first process being placed in a second queue if it is determined that it has spent less time needed in the first queue, the second queue enabling the first process to be scheduled for execution within a longer period of time than the first queue.

5. The method of claim 4 wherein the first process is initially placed at a first location in the first queue, then it is determined whether the first process spent less time than needed when placed at the first location, the first process is then placed at a second location in the first queue if it is determined that it has spent less time than needed in the first location, the second location enabling the first process to be scheduled for execution within a longer period of time than the first location.

6. A computer program product on a computer readable medium for adaptively queueing processes for execution scheduling comprising:
code means for initially scheduling a task using one of a plurality of scheduling options based upon at least one of a default parameter and an application hint; and
code means for subsequently scheduling the task to a different one of the plurality of scheduling options based upon a processing metric.

7. The computer program product of claim 6 wherein the metric is based upon at least one of an amount of wait time, a number of times the task was assigned to a given option, application hints, a number of times or amount of time the task is enqueued on a given queue, a number of times or amount of time a task is enqueued at a given location on a given queue, a number of times a yield is called for a given time interval, and a time between yield calls for a specific task.

8. A computer program product on a computer readable medium for adaptively queueing processes for execution scheduling comprising:
code means for initially placing a first process in a first queue for execution scheduling, the first process yielding a processor on which it is executing to a second process while awaiting release of a shared resource that is being used by a third process;
code means for determining whether the first process spent more time than needed in the first queue; and
code means for placing the first process in a second queue if it is determined that the first process spent more time than needed in the first queue, the second queue enabling the first process to be scheduled for execution in a shorter time than the first queue.

9. The computer program product of claim 8 wherein it is determined whether the first process spent less time than needed in the first queue rather than more time than needed in the first queue, the first process being placed in a second queue if it is determined that it has spent less time needed in the first queue, the second queue enabling the first process to be scheduled for execution within a longer period of time than the first queue.

10. The computer program product of claim 9 wherein the first process is initially placed at a first location in the first queue, then it is determined whether the first process spent less time than needed when placed at the first location, the first process is then placed at a second location in the first queue if it is determined that it has spent less time than needed in the first location, the second location enabling the first process to be scheduled for execution within a longer period of time than the first location.

11. An apparatus for adaptively queueing processes for execution scheduling comprising:
means for initially scheduling a task using one of a plurality of scheduling options based upon at least one of a default parameter and an application hint; and
means for subsequently scheduling the task to a different one of the plurality of scheduling options based upon a processing metric.

12. The apparatus of claim 11 wherein the metric is based upon at least one of an amount of wait time, a number of times the task was assigned to a given option, application hints, a number of times or amount of time the task is enqueued on a given queue, a number of times or amount of time a task is enqueued at a given location on a given queue, a number of times a yield is called for a given time interval, and a time between yield calls for a specific task.

13. An apparatus for adaptively queueing processes for execution scheduling comprising:
means for initially placing a first process in a first queue for execution scheduling, the first process yielding a processor on which it is executing to a second process while awaiting release of a shared resource that is being used by a third process;
means for determining whether the first process spent more time than needed in the first queue; and
means for placing the first process in a second queue if it is determined that the first process spent more time than needed in the first queue, the second queue enabling the first process to be scheduled for execution in a shorter time than the first queue.

14. The apparatus of claim 13 wherein it is determined whether the first process spent less time than needed in the first queue rather than more time than needed in the first queue, the first process being placed in a second queue if it is determined that it has spent less time needed in the first queue, the second queue enabling the first process to be scheduled for execution within a longer period of time than the first queue.

15. The apparatus of claim 14 wherein the first process is initially placed at a first location in the first queue, then it is determined whether the first process spent less time than needed when placed at the first location, the first process is then placed at a second location in the first queue if it is determined that it has spent less time than needed in the first location, the second location enabling the first process to be scheduled for execution within a longer period of time than the first location.

16. A system for adaptively queueing processes for execution scheduling comprising:
at least one storage device for storing code data; and
at least one processor for processing the code data to initially schedule a task using one of a plurality of scheduling options based upon at least one of a default parameter and an application hint, and to subsequently schedule the task to a different one of the plurality of scheduling options based upon a processing metric.

17. The system of claim 16 wherein the metric is based upon at least one of an amount of wait time, a number of times the task was assigned to a given option, application hints, a number of times or amount of time the task is enqueued on a given queue, a number of times or amount of time a task is enqueued at a given location on a given queue, a number of times a yield is called for a given time interval, and a time between yield calls for a specific task.

18. A system for adaptively queueing processes for execution scheduling comprising:
at least one storage device for storing code data; and
at least one processor for processing the code data to initially place a first process in a first queue for execution scheduling, the first process yielding a processor on which it is executing to a second process while awaiting release of a shared resource that is being used by a third process, to determine whether the first process spent more time than needed in the first queue, and to place the first process in a second queue if it is determined that the first process spent more time than needed in the first queue, the second queue enabling the first process to be scheduled for execution in a shorter time than the first queue.

19. The system of claim 18 wherein it is determined whether the first process spent less time than needed in the first queue rather than more time than needed in the first queue, the first process being placed in a second queue if it is determined that it has spent less time needed in the first queue, the second queue enabling the first process to be scheduled for execution within a longer period of time than the first queue.

20. The system of claim 19 wherein the first process is initially placed at a first location in the first queue, then it is determined whether the first process spent less time than needed when placed at the first location, the first process is then placed at a second location in the first queue if it is determined that it has spent less time than needed in the first location, the second location enabling the first process to be scheduled for execution within a longer period of time than the first location.
